(19) United States
(12) Patent Application Publication
(10) Pub. No.: US 2016/0089973 A1
(43) Pub. Date: Mar. 31, 2016

(54) VEHICLE BODY PROTECTION APPARATUS AND METHOD OF USING

(71) Applicant: UMM AL-QURA UNIVERSITY, Makkah (SA)

(72) Inventor: Saleh Abdullah Saleh AL SALAMEH, Al Rass (SA)

(73) Assignee: UMM AL-QURA UNIVERSITY, Makkah (SA)

(21) Appl. No.: 14/391,267

(22) PCT Filed: Sep. 29, 2014
(86) PCT No.: PCT/IB2014/001950

§ 371 Date: Oct. 8, 2014

(51) Int. Cl. B60K 15/04

(52) U.S. Cl. CPC B60K 15/04; B60K 2015/0487

(57) ABSTRACT

Embodiments include a method and apparatus for preventing damage to the paintwork of vehicles caused by spillage of fluids or fuel when refueling. The method includes installing the apparatus into a fuel tank inlet of a vehicle and extending the apparatus from the fuel tank inlet. The apparatus includes a container configured to capture any spillage via a funneling trough extending from the fuel tank inlet to the container. The method further includes raising the apparatus above the fuel tank inlet to return the captured spillage to the fuel tank inlet via the trough. The method also includes retracting and inserting the apparatus into the fuel tank inlet ready for reuse during the next refueling of the vehicle.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Sometimes during refueling from a fuel pump (gasoline pump) for a motorized vehicle, such as, an automobile, a motor bike, sea vessels, and the like, some fuel may pour on the body of the motorized vehicle from either a fueling hose or because of flooding and overflow from a fuel tank. Such, spillage may cause harm to the paint or finish of the motorized vehicle. Further, this fuel may spill upon the ground, thereby threatening habitats and/or ground or sea water to some extent. Also, this fuel may spill upon the pavement and create a hazardous material situation, such as a fire or combustion hazard to others as well as a user.

Thus, a device or apparatus for diverting and collecting spilled fuel would be beneficial for motorized vehicle operators as well as for safety reasons at fuel depots/stations, such as gasoline stations.

### SUMMARY

Embodiments include a vehicle body protection apparatus. The vehicle body protection apparatus includes a fuel capture means for capturing spilled or excess fuel during refueling a vehicle. The vehicle body protection apparatus also includes a fuel diverter means for diverting the spilled or excess fuel to and from the fuel capture means. The vehicle body protection apparatus also includes an attachment means for attaching the fuel diverter means to the vehicle via a vehicle fuel inlet.

Embodiments also include an apparatus having a container configured to store spilled or excess fuel during refueling a vehicle. The apparatus also includes a trough configured to funnel the spilled or excess fuel to and from the container. The apparatus also includes a set of retainer clips configured to attach the trough to the vehicle via a vehicle fuel inlet.

Embodiments also include a vehicle body protection apparatus. The vehicle body protection apparatus includes a container configured to store spilled or excess fuel during refueling a vehicle. The vehicle protection apparatus also includes a trough configured to funnel the spilled or excess fuel to and from the container. The vehicle protection apparatus also includes a set of retainer clips configured to attach the trough to the vehicle via a vehicle fuel inlet. The set of retainer clips are configured to attach to the trough via a press fit configuration. The set of retainer clips are further configured to attach to the vehicle fuel inlet via a snap-fit configuration.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustrative view of a vehicle body protection apparatus according to certain embodiments of the invention.

FIG. 2 an illustrative view of the apparatus of FIG. 1 according to certain embodiments of the invention.

FIG. 3 is a schematic view of the construction of the apparatus of FIG. 1 according to certain embodiments of the invention.

FIGS. 4A and 4B are illustrative views of a retracted state of the apparatus of FIG. 1 prior to and during insertion into a fuel tank inlet according to certain embodiments of the invention.

FIGS. 5A and 5B are illustrative views of retainer clips for the apparatus of FIG. 1 according to certain embodiments of the invention.

FIG. 6 is an illustrative view of a vehicle body protection apparatus according to another embodiment of the invention.

FIGS. 7A to 7C are illustrative views of an install, a fuel capture and a fuel return state, respectively, of the apparatus of FIG. 6 according to certain embodiments of the invention.

FIGS. 8A and 8B are illustrative views of retainer clips for the apparatus of FIG. 6 according to certain embodiments of the invention.

FIG. 9 is a flow chart of a method of using the apparatus of FIG. 1 according to certain embodiments of the invention.

FIG. 10 is a flow chart of a method of using the apparatus of FIG. 6 according to certain embodiments of the invention.

### DETAILED DESCRIPTION OF THE EMBODIMENTS

Referring now to the drawings, wherein like reference numerals designate identical or corresponding parts throughout the several views.

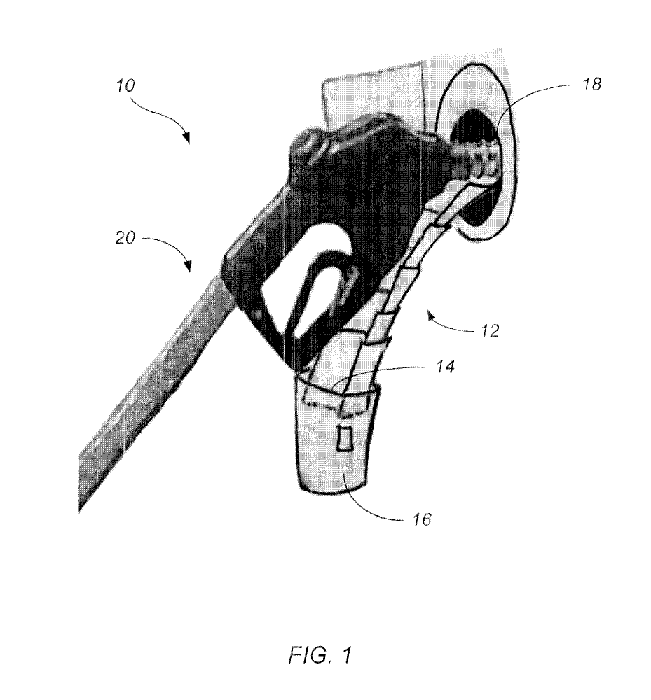

FIG. 1 is an illustrative view of a vehicle body protection apparatus 10 according to certain embodiments of the invention. In FIG. 1, apparatus 10 is shown engaged with both a fuel tank inlet 18 and a fueling nozzle 20 which may be connected to a gas pump (not shown) for refueling purposes. Apparatus 10 may include a set of cups portion 12, and a container 16 having a container opening 14. The vehicle body protection apparatus 10 may be configured to provide a barrier (at 12) between a motorized vehicle and any spilled or excess fuel entering fuel tank inlet 18.

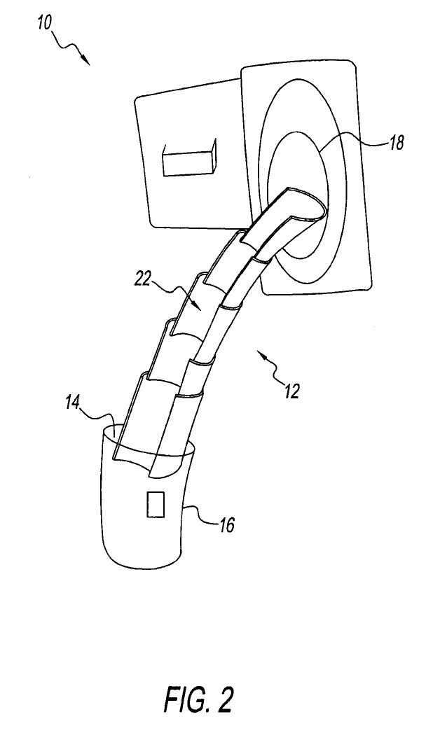

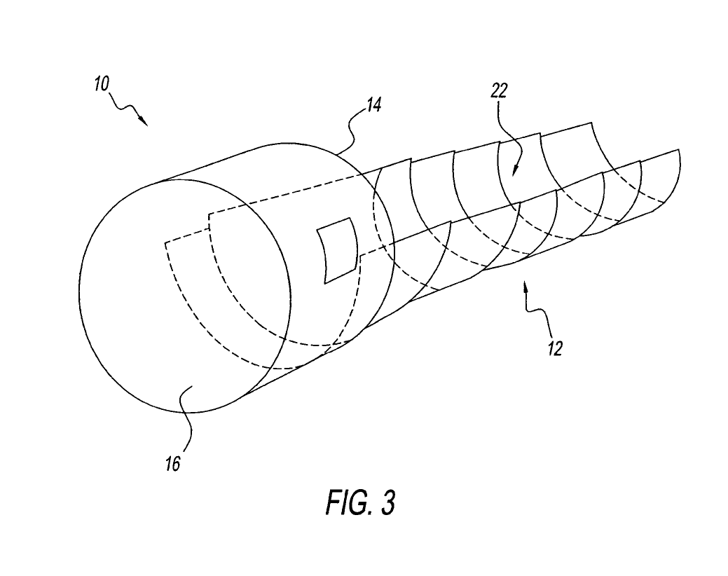

The set of cups portion 12 may include cups which are configured to be in accord with each other yet successively smaller sized cups from the container 16 up to fuel tank inlet 18 with the smallest cup disposed at inlet 18. The set of cups portion 12 may be configured to be slidably interlocked with each other and the container 16. Further, set of cups 12 may be configured to form a trough 22 when the set of cups portion 12 are in an extended state (see FIGS. 2 and 3). Trough 22 may be configured to extend from inlet 18 to container 16 when in this extended state, and trough 22 may be formed as a channel or gutter to direct and flow any fuel spillage either to container 16 or back to inlet 18, as discussed below.

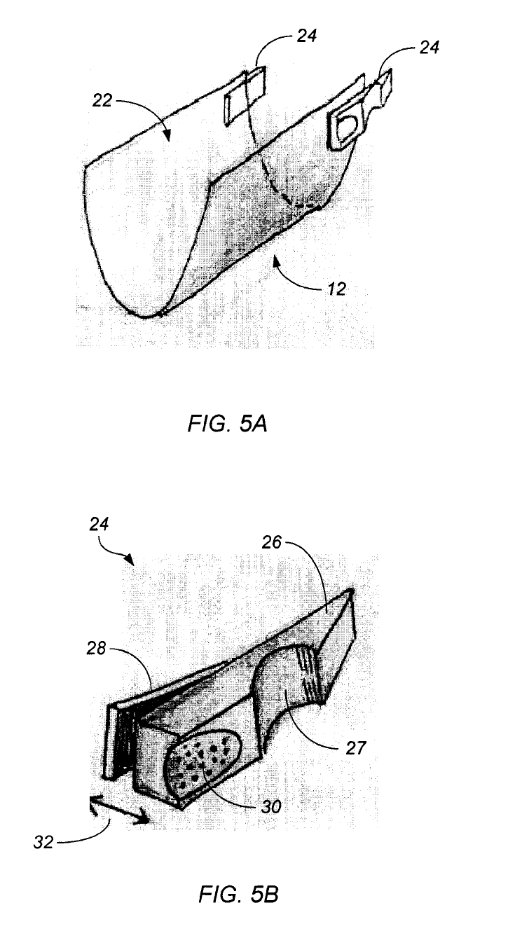

In other words, a relatively small apparatus 10 comprises of a number of smaller parts that are similar in form to a set of cups 12 cut longitudinally, and each cup may be configured to be inserted inside the previous cup and the subsequent cup and so forth with this resembling the largely shaped trough 22, whereas the latter cup is closed from the bottom, that is, apparatus 10, in order to hold any spilled or excess fuel, and apparatus 10 may be installed and fixed to the inlet 18 of the fuel tank via the set of cups 12 and a set of retainer clips 24 (see FIGS. 5A and 5B). Thus, the set of cups 12 may be configured to form a substantially semi-cylindrical channel or gutter extending between container 16 and inlet 18.

FIG. 2 an illustrative view of the apparatus 10 of FIG. 1 according to certain embodiments of the invention. In FIG. 2, apparatus 10 is shown without fueling nozzle 20 where trough 22 is more clearly shown leading from inlet 18 to container 16 in a funneling configuration to capture any spilled or excess fuel. Also, in FIG. 2, the set of cups 12 more clearly show the successively smaller cup size from container opening 14 and container 16 to inlet 18, as discussed above.

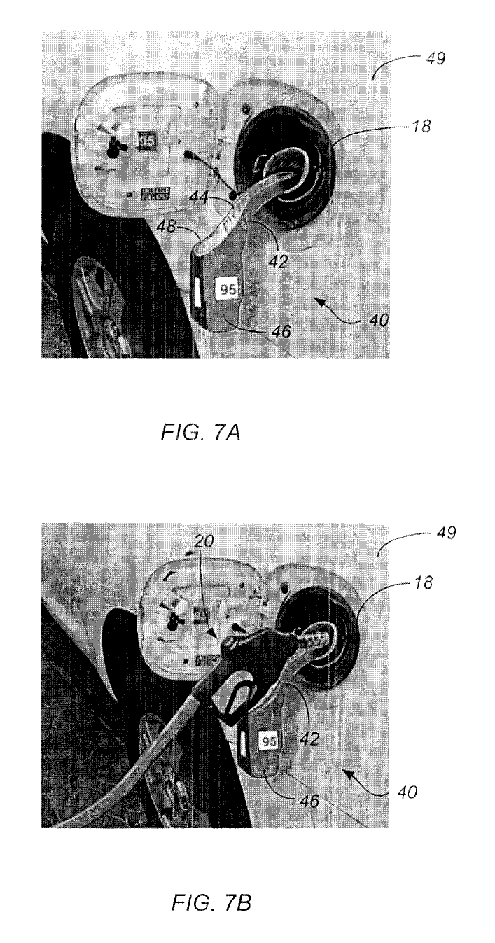

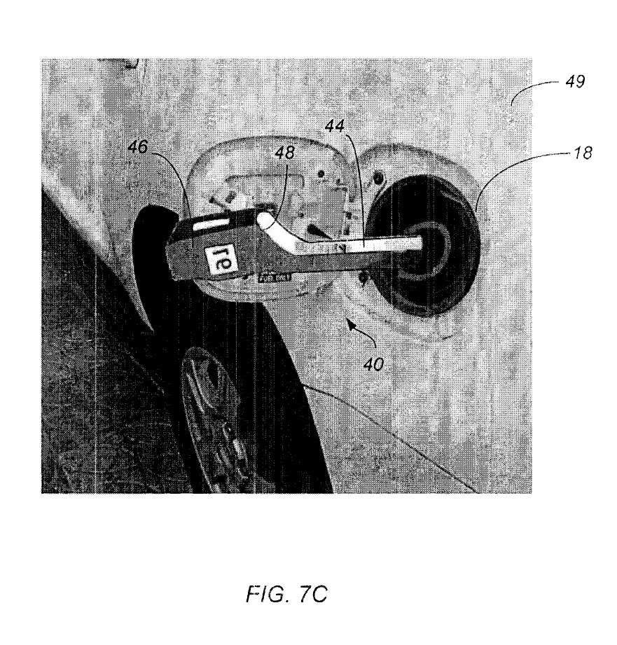

FIG. 3 is a schematic view of the construction of the apparatus 10 of FIG. 1 according to certain embodiments of the invention. In FIG. 3, the construction of apparatus 10, including the set of cups 12 configured to be successively smaller as they extend from container opening 14 of container 16 to inlet 18. Further, as the set of cups 12 are in their extended state, they form a trough 22 configured to capture any spilled or overflow of fuel, thereby protecting the body of the motorized vehicle (see FIGS. 7A to 7C). Trough 22 may be configured to funnel or divert away any spilled or excess fuel away from the body of the motorized vehicle. In FIG. 3, apparatus 10 is shown in an extended state which may be proximal to inlet 18, as similarly shown in FIGS. 1 and 2. In this extended state, apparatus 10 may be configured to capture and then return any excess or spilled fuel while simultaneously protecting the body of the motorized vehicle.

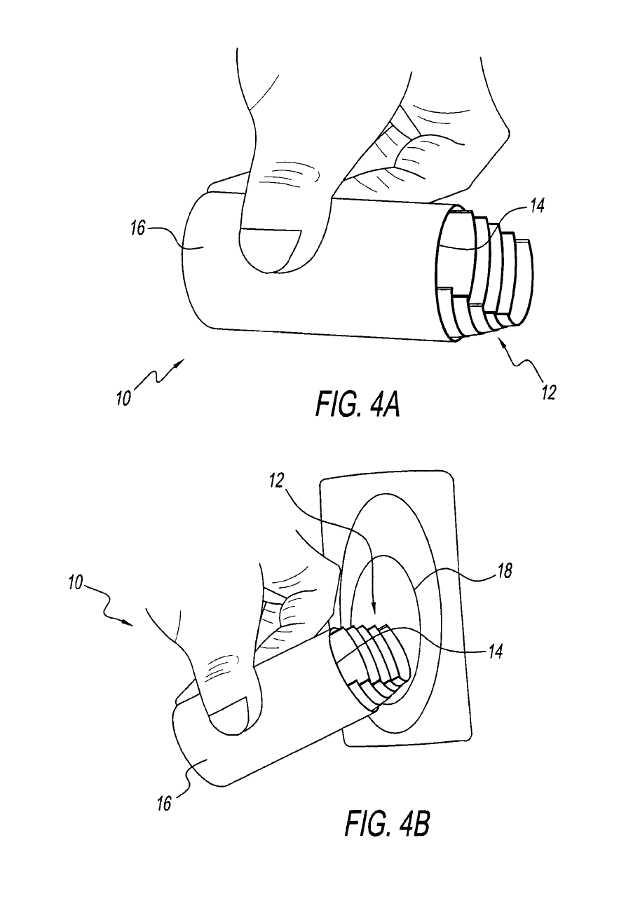

FIGS. 4A and 4B are illustrative views of a retracted state of the apparatus 10 of FIG. 1 prior to and during insertion into a fuel tank inlet 18 according to certain embodiments of the invention. In FIG. 4A, apparatus 10 is shown in its retracted state. In this retracted or collapsed state, apparatus 10 may either be extended from fuel tank inlet 18 to capture fuel spillage and thereby protect the motorized vehicle or apparatus 10 may be inserted into inlet 18 for later use during refueling. In FIG. 4B, apparatus 10 is shown in its retracted state while being inserted within inlet 18 by a user for storage and later repeated use when refueling the vehicle (see arrow). Further, apparatus 10 may be formed and configured to fit completely within inlet 18 of the fuel tank of the motorized vehicle in this retracted state.

In other words, the set of cups 12 of apparatus 10 may be configured to extend from container 16 to inlet 18 prior to refueling in order to capture any fuel spills or overflow from inlet 18. Upon refueling and capturing any fuel spills or overflow, the captured fuel may be returned to inlet 18 by upwardly tilting apparatus 10 above inlet 18 to cause the captured fuel to flow via trough 22 back to inlet 18. Next, the set of cups 12 may be retracted or collapsed down into container 16 and later inserted into inlet 18 for later reuse during refueling.

FIGS. 5A and 5B are illustrative views of retainer clips 24 for the apparatus 10 of FIG. 1 according to certain embodiments of the invention. In FIG. 5A, a portion of the set of cups 12 is shown. This portion of the set of cups 12 is the smallest cup which is configured to contact inlet 18. The portion also shows the trough 22 which leads to and from container 16. A set of retainer clips 24 may be configured at one end to hold by a press fit the portion 28 of the set of cups 12. In some embodiments the set of retainer clips 24 may include at least two retainer clips attached to the set of cups 12 (see FIG. 5A). At an opposite end, retainer clips 24 may be configured to attach to the inlet 18 by a snap-fit configuration. In FIG. 5B, retainer clips 24 may include a wedge-shaped portion 26 at one end configured for easy insertion into inlet 18, a first engagement portion 28, where the first engagement portion 28 may be configured as a press fit portion at an opposite end to engage the set of cups 12 (smallest cup), a second engagement portion 27, where the second engagement portion 27 may be configured as a concaved snap-fit portion disposed adjacent to the wedge-shaped portion 26, and a finger grip portion 30 configured to assist when installing the apparatus 10 by inserting the wedge-shaped portion 26 into inlet 18. The first engagement portion 28 is spaced apart at 32 from the finger grip portion 30. Retainer clips 24 may further be configured to be detachable from inlet 18 in order to easily replace worn parts thereof.

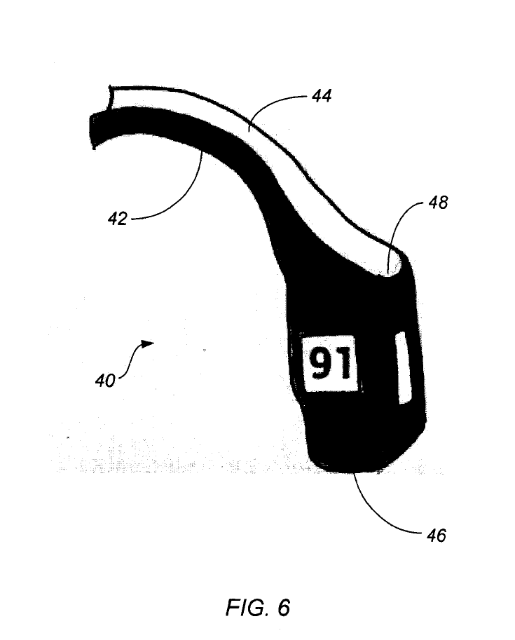

FIG. 6 is an illustrative view of a vehicle body protection apparatus 40 according to another embodiment of the invention. In FIG. 6, apparatus 40 may include a flexible neck portion 42 configured to be open on one side to form a trough portion 44, a container 46 configured to hold any spilled fuel, when the container 46 includes a container opening 48. Similar to the embodiment discussed above, apparatus 40 may be configured to capture any spilled or overflowed fuel when refueling a motorized vehicle body 49 (see FIG. 7A) via fuel nozzle 20 (see FIG. 7B). Apparatus 40 may be configured to snuggly fit within fuel tank inlet 18 of the motorized vehicle body 49 via a distal end of neck portion 42 opposite container opening 48. Trough portion 44 may be formed as a channel or gutter to direct the flow of any fuel spillage to container 46 or back to fuel tank inlet 18, as discussed below.

FIGS. 7A to 7C are illustrative views of an install, a fuel capture and a fuel return state, respectively, of the apparatus 40 of FIG. 6 according to certain embodiments of the invention. In FIG. 7A, apparatus 40 is shown installed or inserted into inlet 18 of a motorized vehicle at 49 in a first state for installation. In FIG. 7B, apparatus 40 is shown as in FIG. 7A but with a fuel nozzle 20 inserted into inlet 18 to begin refueling the motorized vehicle at 49 in a second state for fuel capture. In FIG. 7C, apparatus 40 is shown with fuel nozzle 20 removed and apparatus 40 being tilted to a third state of returning any excess or spilled fuel back to the motorized vehicle at 49 via inlet 18, thereby both protecting the motorized vehicle body 49 and saving fuel that otherwise may have been wasted or presented a chemical hazard.

In other words, this embodiment shows a small fuel flood container 40 which is open from the top (at 48), and has a neck portion 42 which may be configured to be flexible/bendable and open in the top (at 44). This embodiment may be similar to the above embodiments, but may differ in that the container 40 is not installed in the inlet 18 of the fuel tank on a permanent basis, but rather container 40 may be placed or disposed in the vicinity of a fuel (gas) station and used at the time of refueling as shown in FIG. 7B, for example. Small clips 50 disposed at a distal end of the neck portion 42 may be configured to install container 40 in the inlet 18 of the fuel tank.

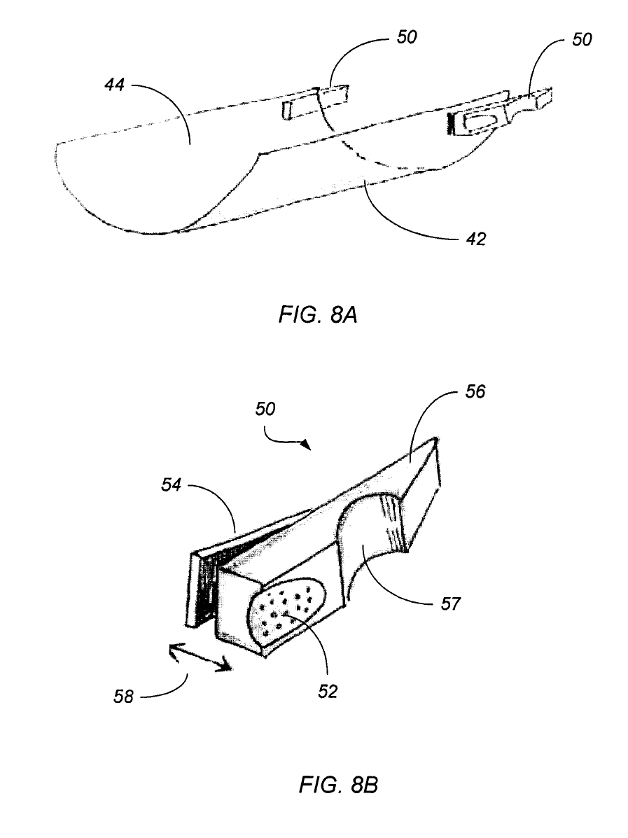

FIGS. 8A and 8B are illustrative views of retainer clips 50 for the apparatus 40 of FIG. 6 according to certain embodiments of the invention. In FIG. 8A, a part of neck portion 42 is shown. Neck portion 42 may be configured to be sized to fit inlet 18 as shown in FIG. 7A. Neck portion 42 also shows the trough portion 44 which leads to container 46. Retainer clips 50 may be configured at one end to hold the neck portion 42 by a press fit the portion 54. Retainer clips 50 may also be configured at an opposite end to attach to the inlet 18 by a snap-fit configuration. In FIG. 8B, retainer clips 50 may include a wedge-shaped portion 56 at one end configured for easy insertion into inlet 18, a first engagement portion 54, where the first engagement portion 28 may be configured as a press fit portion at an opposite end to engage the neck portion 42, a second engagement portion 57, where the second engagement portion 57 may be configured as a concaved snap-fit portion disposed adjacent to the wedge-shaped portion 56, and a finger grip portion 52 configured to assist when installing the apparatus 40 by inserting the wedge-shaped portion 56 into inlet 18. The first engagement portion 58 is spaced apart at 58 from the finger grip portion 52. Retainer clips 50 may further be configured to be detachable from inlet 18 in order to easily be reused by a subsequent user when refueling.

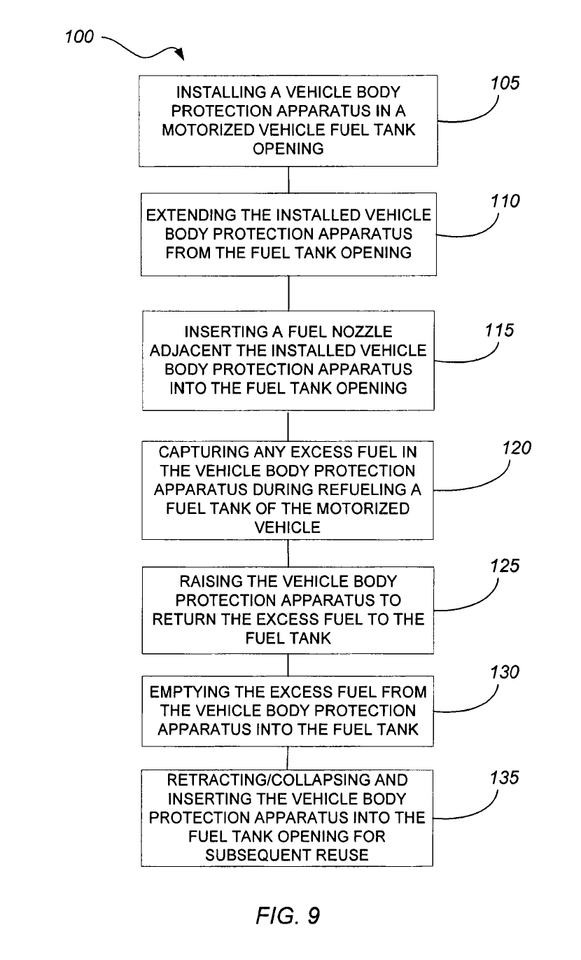

FIG. 9 is a flow chart of a method 100 of using the apparatus 10 of FIG. 1 according to certain embodiments of the invention. In FIG. 9, at 105, apparatus 10 may be installed in a motorized vehicle fuel tank inlet 18 via retainer clips 24. At 110, installed apparatus 10 may be retracted from inlet 18 in order to extend the set of cups 12. At 115, fuel nozzle 20 may be inserted into inlet 18 adjacent to installed apparatus 10. At 120, during filling the fuel tank via inlet 18, any spilled or excess fuel is captured by apparatus 10 via trough 22 and container 16. At 125, apparatus 10 may be raised above inlet 18 to cause the captured spilled or excess fuel to return to the fuel tank via inlet 18 and trough 22. At 130, container 16 may be emptied of its contents via trough 22 into inlet 18. At 135, the now emptied apparatus 10 may be collapsed via set of cups 12 towards inlet 18 and inserted into inlet 18 for subsequent use when refueling.

In other words, apparatus 10 may be installed and fixed to inlet 18 of the fuel tank permanently via retainer clips 24 and thus, apparatus 10 may be used whenever the motorized vehicle at 49 needs to be refueled. After apparatus 10 is fixedly attached to inlet 18, method 100 may include the following: (1) before refueling the vehicle, apparatus 10 is used by inserting apparatus 10 inside inlet 18 of the tank permanently via clips 24; (2) at the time of refueling the vehicle, apparatus 10 is pulled/extracted from fuel tank inlet 18 and set against or adjacent the vehicle body 49, then fuel nozzle 20 is inserted into inlet 18 of the tank (see FIG. 1); (3) after refueling is completed, fuel nozzle 20 is removed from inlet 18 and apparatus 10, then apparatus 10 is lifted above inlet 18 to return any spilled or excess fuel back to the fuel tank via inlet 18; and (4) after returning the spilled or excess fuel, as discussed above, the fuel tank cap (not shown) of the fuel tank is re-installed, the last cup of the set of cups 12 of apparatus 10 is pushed to be disposed inside inlet 18 of the fuel tank, and the cover is closed, ready to be reused for the next refueling.

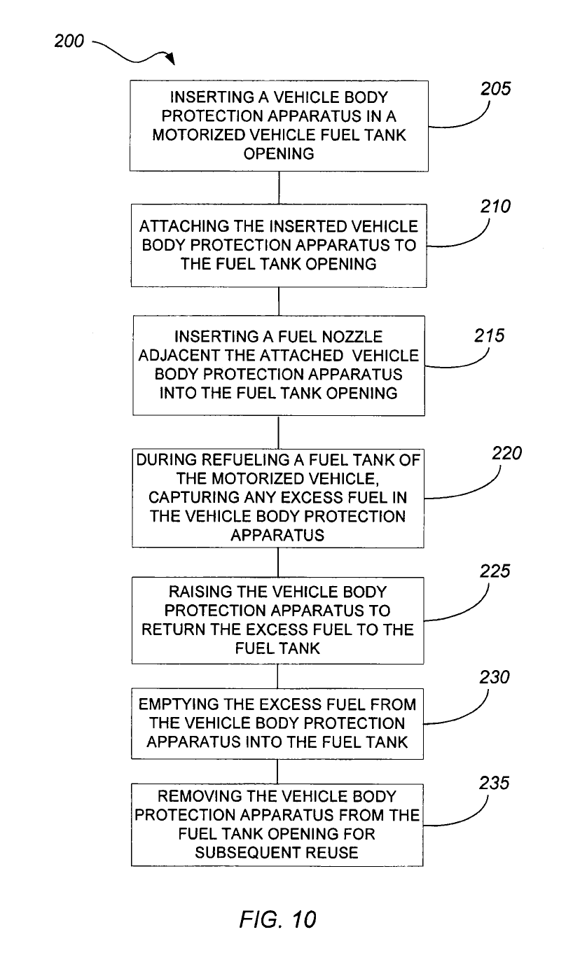

FIG. 10 is a flow chart of a method 200 of using the apparatus 40 of FIG. 6 according to certain embodiments of the invention. In FIG. 10, at 205, apparatus 40 may be inserted into inlet 18 of the fuel tank of a motorized vehicle at 49. At 210, apparatus 40 may be installed in inlet 18 via retainer clips 50. At 215, fuel nozzle 20 may be inserted into inlet 18 for refueling the motorized vehicle at 49. At 220, during filling the fuel tank via inlet 18, any spilled or excess fuel is captured by apparatus 40 via trough portion 44 and container 46. At 225, apparatus 40 may be raised above inlet 18 to cause the captured spilled or excess fuel to return to the fuel tank via inlet 18 and trough portion 44. At 230, container 46 may be emptied of its contents via trough portion 44 into inlet 18. At 235, the now emptied apparatus 40 may be removed from inlet 18 by applying sufficient pressure to retainer clips 50 at finger grip portion 52 to release retainer clips 50 and thereby apparatus 40 from inlet 18 for subsequent use when refueling.

Method 200 is similar to method 100 discussed above, except that apparatus 40 is not configured to be permanently attached to inlet 18 or to be inserted therein. In other words, method 200 may include (1) before refueling the motorized vehicle, the apparatus 40 may be inserted at neck portion 42 to be inside inlet 18 of the tank (see FIG. 7A). Next, (2) apparatus 40 may be temporarily attached to inlet 18 via retainer clips 50. Further, the fuel nozzle 20 for refueling may be inserted in inlet 18 of the tank (see FIG. 7B). Then, (3) after refueling, the fuel nozzle 20 may be removed from inlet 18 and apparatus 40. Next, (4) then the apparatus 40 may be lifted up to return the flood/spilled/excess fuel back to the fuel tank via inlet 18 (see FIG. 7C). Finally, the apparatus 40 may be removed from inlet 18 and set aside for subsequent use during a refueling of a motorized vehicle.

In some embodiments, apparatus 40 may include fuel octane/type (diesel) designations as to prevent accidental or unwanted mixing of fuel types when capturing any fuel spillage when refueling. Further, apparatus 40 may include a variety of neck portion 42 and/or trough portion 44 sizes to accommodate or match different sized or types of inlet 18 for fuel tanks of motorized vehicles, for example, trucks, cars, boats, motorcycles, etc. Also, retainer clips 50 may vary in size as appropriate based on OEM/standard parts at inlet 18.

In addition, the above described apparatuses (10, 40) may be configured to be formed from any of a group of materials consisting of aluminum, steel, plastic, or the like. For example, the apparatuses (10, 40) may be formed of high-density polyethylene (HDPE) which in turn may be recycled for environmental purposes when worn by frequent use. HDPE is resistant to many different solvents and fuels. HDPE has a wide variety of applications, for example, fuel tanks and fuel tank caps for vehicles.

Alternatively, the flexible neck portion 42 of apparatus 40 may be replaced by a semi-cylindrical accordion-type flexible neck portion (not shown). Also, this neck portion may be formed from plastic, such as, HDPE in a similar manner as conventional flexible gas can dispensing necks/tubes.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

The above disclosure also encompasses the embodiments noted below.

(1) A vehicle body protection apparatus, comprising: a fuel capture means for capturing spilled or excess fuel during refueling a vehicle; a fuel diverter means for diverting the spilled or excess fuel to and from the fuel capture means; and an attachment means for attaching the fuel diverter means to the vehicle via a vehicle fuel inlet.

(2) The vehicle body protection apparatus according to (1), wherein the fuel diverter means includes a trough configured to funnel the spilled or excess fuel away from the vehicle fuel inlet.

(3) The vehicle body protection apparatus according to (1) or (2), wherein the fuel capture means includes a container configured to store the spilled or excess fuel.

(4) The vehicle body protection apparatus according to (1) to (3), wherein the fuel capture means and the fuel diverter means are formed from a group of materials consisting of aluminum, steel, plastic, and high-density polyethylene (HDPE).

(5) The vehicle body protection apparatus according to (1) to (4), wherein the attachment means includes a set of retainer clips configured to attach the fuel diverter means to the vehicle fuel inlet.

(6) The vehicle body protection apparatus according to (1) to (5), wherein the fuel diverter means is configured to be bendable.

(7) The vehicle body protection apparatus according to (1) to (6), wherein the fuel diverter means is configured to be collapsible and stored within the vehicle fuel inlet for subsequent use.

(8) The vehicle body protection apparatus according to (1) to (7), wherein the fuel diverter means is configured to be permanently attached to the vehicle fuel inlet by the attachment means.

(9) The vehicle body protection apparatus according to (1) to (8), wherein the set of retainer clips are configured to attach to the fuel diverter means via a press fit configuration.

(10) The vehicle body protection apparatus according to (1) to (9), wherein the set of retainer clips are further configured to attach to the vehicle fuel inlet via a snap-fit configuration.

(11) The vehicle body protection apparatus according to (1) to (10), wherein the set of retainer clips are further configured to detach from the vehicle fuel inlet upon receiving a predetermined pressure to a predetermined portion of each clip to initiate a release from the vehicle fuel inlet.

(12) An apparatus, comprising: a container configured to store spilled or excess fuel during refueling a vehicle; a trough configured to funnel the spilled or excess fuel to and from the container; and a set of retainer clips configured to attach the trough to the vehicle via a vehicle fuel inlet.

(13) The apparatus according to (12), wherein the trough is configured to funnel the spilled or excess fuel away from the vehicle fuel inlet.

(14) The apparatus according to (12) or (13), wherein the container and the trough are formed from a group of materials consisting of aluminum, steel, plastic, and high-density polyethylene (HDPE).

(15) The apparatus according to (12) to (14), wherein the trough is configured to be bendable.

(16) The apparatus according to (12) to (15), wherein the trough is configured to be collapsible and stored within the vehicle fuel inlet for subsequent use.

(17) The apparatus according to (12) to (16), wherein the trough is configured to be permanently attached to the vehicle fuel inlet by the set of retainer clips.

(18) The apparatus according to (12) to (17), wherein the set of retainer clips are configured to attach to the trough via a press fit configuration.

(19) The apparatus according to (12) to (18), wherein the set of retainer clips are further configured to attach to the vehicle fuel inlet via a snap-fit configuration.

(20) The apparatus according to (12) to (19), wherein the set of retainer clips are further configured to detach from the vehicle fuel inlet upon receiving a predetermined pressure to a predetermined portion of each clip to initiate a release from the vehicle fuel inlet.

(21) A vehicle body protection apparatus, comprising: a container configured to store spilled or excess fuel during refueling a vehicle; a trough configured to funnel the spilled or excess fuel to and from the container; and a set of retainer clips configured to attach the trough to the vehicle via a vehicle fuel inlet, wherein the set of retainer clips are configured to attach to the trough via a press fit configuration, and wherein the set of retainer clips are further configured to attach to the vehicle fuel inlet via a snap-fit configuration.

1. A vehicle body protection apparatus, comprising:
a fuel capture means for capturing spilled or excess fuel during refueling a vehicle;
a fuel diverter means for diverting the spilled or excess fuel to and from the fuel capture means; and
an attachment means for attaching the fuel diverter means to the vehicle via a vehicle fuel inlet.

2. The vehicle body protection apparatus according to claim 1, wherein the fuel diverter means includes a trough configured to funnel the spilled or excess fuel away from the vehicle fuel inlet.

3. The vehicle body protection apparatus according to claim 1, wherein the fuel capture means includes a container configured to store the spilled or excess fuel.

4. The vehicle body protection apparatus according to claim 1, wherein the fuel capture means and the fuel diverter means are formed from a group of materials consisting of aluminum, steel, plastic, and high-density polyethylene (HDPE).

5. The vehicle body protection apparatus according to claim 1, wherein the attachment means includes a set of retainer clips configured to attach the fuel diverter means to the vehicle fuel inlet.

6. The vehicle body protection apparatus according to claim 1, wherein the fuel diverter means is configured to be bendable.

7. The vehicle body protection apparatus according to claim 1, wherein the fuel diverter means is configured to be collapsible and stored within the vehicle fuel inlet for subsequent use.

8. The vehicle body protection apparatus according to claim 1, wherein the fuel diverter means is configured to be permanently attached to the vehicle fuel inlet by the attachment means.

9. The vehicle body protection apparatus according to claim 5, wherein the set of retainer clips are configured to attach to the fuel diverter means via a press fit configuration.

10. The vehicle body protection apparatus according to claim 9, wherein the set of retainer clips are further configured to attach to the vehicle fuel inlet via a snap-fit configuration.

11. The vehicle body protection apparatus according to claim 10, wherein the set of retainer clips are further configured to detach from the vehicle fuel inlet upon receiving a predetermined pressure to a predetermined portion of each clip to initiate a release from the vehicle fuel inlet.

12. An apparatus, comprising:
a container configured to store spilled or excess fuel during refueling a vehicle;
a trough configured to funnel the spilled or excess fuel to and from the container; and
a set of retainer clips configured to attach the trough to the vehicle via a vehicle fuel inlet.

13. The apparatus according to claim 12, wherein the trough is configured to funnel the spilled or excess fuel away from the vehicle fuel inlet.

14. The apparatus according to claim 12, wherein the container and the trough are formed from a group of materials consisting of aluminum, steel, plastic, and high-density polyethylene (HDPE).

15. The apparatus according to claim 12, wherein the trough is configured to be bendable.

16. The apparatus according to claim 12, wherein the trough is configured to be collapsible and stored within the vehicle fuel inlet for subsequent use.

17. The apparatus according to claim 12, wherein the trough is configured to be permanently attached to the vehicle fuel inlet by the set of retainer clips.

18. The apparatus according to claim 12, wherein the set of retainer clips are configured to attach to the trough via a press fit configuration.

19. The apparatus according to claim 12, wherein the set of retainer clips are further configured to attach to the vehicle fuel inlet via a snap-fit configuration.

20. The apparatus according to claim 12, wherein the set of retainer clips are further configured to detach from the vehicle fuel inlet upon receiving a predetermined pressure to a predetermined portion of each clip to initiate a release from the vehicle fuel inlet.

21. A vehicle body protection apparatus, comprising:
a container configured to store spilled or excess fuel during refueling a vehicle;
a trough configured to funnel the spilled or excess fuel to and from the container; and
a set of retainer clips configured to attach the trough to the vehicle via a vehicle fuel inlet,
wherein the set of retainer clips are configured to attach to the trough via a press fit configuration, and
wherein the set of retainer clips are further configured to attach to the vehicle fuel inlet via a snap-fit configuration.
